(19) United States
(12) Patent Application Publication
(10) Pub. No.: US 2007/0051451 A1
(43) Pub. Date: Mar. 8, 2007

(54) Systems and Methods for Non-Perpendicular Ultrasonic Plastic Welding

(76) Inventors: Saeed Mogadam, Newton, MA (US); Donald Patten, Lake Geneva, WI (US); Tony DiFinizio, Tewksbury, MA (US); Shane Beam, Wilmington, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/470,764

(22) Filed: Sep. 7, 2006

Related U.S. Application Data
(60) Provisional application No. 60/715,306, filed on Sep. 8, 2005.

(51) Int. Cl. B32B 37/00; B32B 37/06; B29C 65/00

(52) U.S. Cl. 156/73.1; 156/73.4; 156/580.2

(57) ABSTRACT

Systems for ultrasonically welding described herein include a sonotrode for delivering ultrasonic vibrations to two or more plastic sheets, so as to form a weld between them. The sonotrode and the plastic sheets are arranged such that the ultrasonic vibrations delivered by the sonotrode travel along a path that is oriented at an angle α with respect to a tangent to the surface being welded, wherein the angle α is less than 90 degrees. Methods for ultrasonically welding described herein include providing two or more plastic sheets to be welded together and delivering ultrasonic vibrations to form a weld between them, such that the ultrasonic vibrations travel along a path that is oriented at an angle α with respect to a tangent to the surface being welded, wherein the angle α is less than 90 degrees.

### REFERENCE TO RELATED APPLICATIONS

This application claims the right of priority to U.S. Provisional Application No. 60/715,306, filed Sep. 8, 2005, which is hereby incorporated herein by reference.

### BACKGROUND OF THE INVENTION

1. Field of the Invention

This disclosure related to systems and methods for the ultrasonic welding of plastic sheets.

2. Background Information

A typical prior art system for ultrasonically welding plastic sheets is shown in FIG. 4A. As shown in FIG. 4A, a typical system 400 includes an anvil 410 upon which the sheets 420, 430 rest and a sonotrode 440 that delivers ultrasonic vibrations to the sheets 420, 430, so as to create a weld between them. The anvil 410 and the sonotrode 440 may be similar to devices described in U.S. Pat. Nos. 4,596,352, 4,646,957, 4,869,419, 5,941,443, and 6,079,608 and U.S. patent application Ser. No. 10/389,454, the contents of all of which documents are expressly incorporated by reference herein in their entireties.

During operation of a system such as the one illustrated in FIG. 4, the sonotrode 440 is displaced so as to exert a vertical compression force on the sheets 420, 430. The sonotrode 440 and the sheets 420, 430 are aligned such that the ultrasonic vibrations delivered by the sonotrode 440 travel along paths that are perpendicular to the sheets 420, 430 (the ultrasonic vibrations are represented schematically by arrow 450). This alignment is commonly referred to as a vertical configuration, a perpendicular configuration, or a “plunge weld” configuration. In this configuration a weld is achieved because the transfer of ultrasonic energy to the workpieces causes them to heat up and partially melt, forming a bond when the material re-sets.

While a plunge-weld system such as system 400 can perform well in many situations involving the welding of plastic sheets, the performance of such a system has been observed to deteriorate when welding plastic sheets having a thickness of less than about 5-6 mils (0.13-0.15 mm). It can be difficult to achieve consistent quality in such welds because the ultrasonic energy delivered in the plunge weld configuration can cause thin plastic sheets to which the energy is applied to melt excessively, often destroying the material at the seam or cutting through it, rather than creating a strong bond. Although the extent of the melting caused by the welding can be controlled for non-moving sheets by controlling the power level at which the ultrasonic welder operates, such a solution is not always feasible for continuous welding of moving materials. This is so because the power level must be high enough to achieve melting even in the short time that any area of a moving workpiece spends under the ultrasonic sonotrode. Thus, achieving precise control of applied power to obtain a high-quality continuous weld can be difficult.

Similar difficulties can arise for those applications that involve the formation of tubes from a single sheet, such as a single plastic sheet, that is to be welded onto itself. Specifically, in traditional plastic plunge welders, such as illustrated in FIG. 4B, the sonotrode cannot roll along the seam because of its vertical configuration. Nor is it feasible to rotate the anvil 410 about the axis 470 in order to feed the seam through the device, moving the rolled sheet 460 into or out of the plane of the page.

### SUMMARY OF THE INVENTION

Systems and methods for ultrasonically welding plastic are described that address the above difficulties, as well as presenting additional advantages.

In some embodiments, systems for ultrasonically welding include a sonotrode configured for delivering ultrasonic vibrations to two or more plastic sheets to be welded, so as to form a weld between them. The sonotrode and the plastic sheets are arranged such that the ultrasonic vibrations delivered by the sonotrode travel along a path that is oriented at an angle α with respect to a tangent to the surface being welded, e.g., the surface of the one of the plastic sheets that is disposed nearest to the sonotrode. The angle α is less than 90 degrees. In some embodiments, the angle α is less than about 65 degrees and greater than about 8 degrees. In some embodiments the angle α is about 45 degrees.

In some embodiments, methods for ultrasonically welding include providing two or more plastic sheets to be welded together and delivering ultrasonic vibrations to the plastic sheets so as to form a weld there between, such that the ultrasonic vibrations travel along a path that is oriented at an angle α with respect to a tangent to the surface being welded, e.g., the surface of the one of the plastic sheets that is disposed nearest to the sonotrode. The angle α is less than 90 degrees. In some embodiments, the angle α is less than about 65 degrees and greater than about 8 degrees. In some embodiments, the angle α is about 45 degrees.

In some embodiments, the plastic sheets to be welded together are two or more separate sheets. Alternatively and/or in combination, in some embodiments, the plastic sheets to be welded together include two or more portions of a single plastic sheet.

The plastic sheets may include thermoplastic sheets, including without limitation, sheets of nylon, polypropylene, polyethylene, polystyrene, and polyester.

The plastic sheets may have a variety of sheet thicknesses. In one embodiment, two plastic sheets are welded together, in which each sheet has a thickness less than about 5-6 mils (0.13-0.15 mm). In other embodiments, a continuous weld is made between two or more plastic sheets (or two or more portions of a single sheet) having thickness less than about 2-4 mils (0.05-0.10 mm).

These and other features of the disclosed systems and methods can be more fully understood by referring to the following detailed description and the accompanying drawings.

### BRIEF DESCRIPTION OF THE DRAWINGS

The invention description below refers to the accompanying drawings, of which:

FIGS. 1A and 1B illustrate an exemplary system for ultrasonically welding sheets of material.

FIGS. 2A and 2B illustrate exemplary weld zones produced by the exemplary system of FIGS. 1A and 1B.

FIG. 3 illustrates the actions involved in generating a weld zone with the exemplary system of FIGS. 1A and 1B.

FIG. 4A illustrates a system for ultrasonically welding sheets of material, such as plastic sheets.

FIG. 4B illustrates a configuration that presents difficulty for welding a tube from a single sheet of material.

FIG. 5 illustrates a system for ultrasonically welding sheets of metal.

### DETAILED DESCRIPTION OF AN ILLUSTRATIVE EMBODIMENT

Illustrative embodiments will now be described to provide an overall understanding of the disclosed systems and methods. Those of ordinary skill in the art will understand that the disclosed systems and methods can be adapted and modified to provide systems and methods for other applications, and that other additions and modifications can be made to the disclosed systems and methods without departing from the scope of the present disclosure. For example, features of the embodiments can be combined, separated, interchanged, and/or rearranged to generate other embodiments. Such modifications and variations are intended to be included within the scope of the present disclosure.

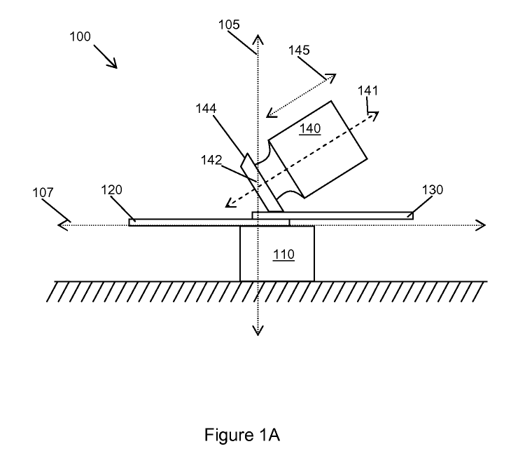

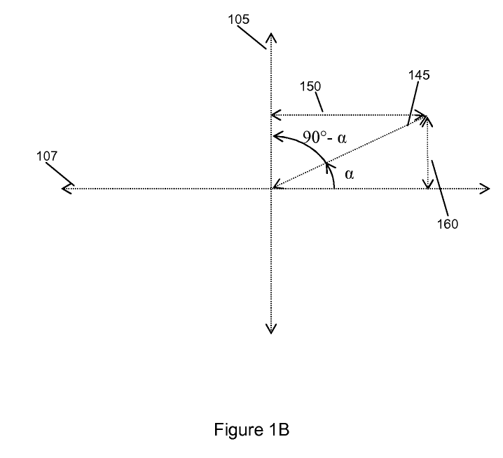

FIGS. 1A and 1B illustrate an exemplary system for ultrasonically welding plastic sheets. As shown in FIG. 1A, the system 100 includes an anvil 110 upon which the sheets 120, 130 are disposed and a sonotrode 140, having a working end 142, for delivering ultrasonic vibrations 145 to the sheets 120, 130, so as to create a weld there between. As illustrated in FIG. 1A, the working end 142 may have a beveled edge 144 to facilitate the placement of the sonotrode at an angle while maintaining contact with the workpieces. The width of the beveled edge may be selected depending upon the desired width of the welded seam.

During operation, the sonotrode 140 is displaced so as to exert a compression force on the sheets 120, 130 in direction 105, perpendicular to the sheets. As shown in FIGS. 1A and 1B, the sonotrode 140 and the sheets 120, 130 are aligned such that the ultrasonic vibrations 145 delivered by the sonotrode 140 travel along paths that are oriented at an angle α with respect to a tangent to the surface being welded, e.g., the surface of the sheet that is disposed nearest to the sonotrode 140, i.e., sheet 130. This surface is represented by axis 107. (Equivalently, the ultrasonic vibrations 145 travel along paths that are oriented at an angle 90-α with respect to a perpendicular to the surface being welded; the perpendicular is represented by axis 105.) This alignment is referred to herein as a non-perpendicular configuration or non-perpendicular alignment. As will become apparent below, delivering the ultrasonic vibration 145 at a non-perpendicular angle α results in a weld of improved strength and quality compared to the traditional plunge weld method for certain thicknesses and/or configurations of the workpieces.

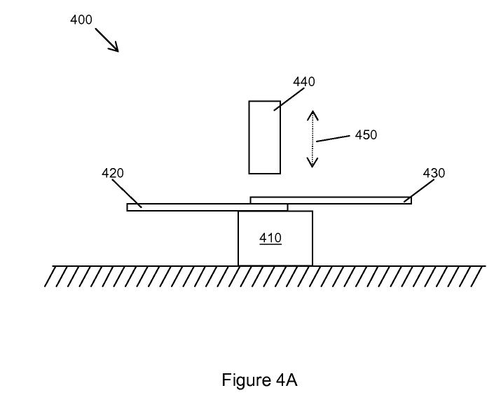

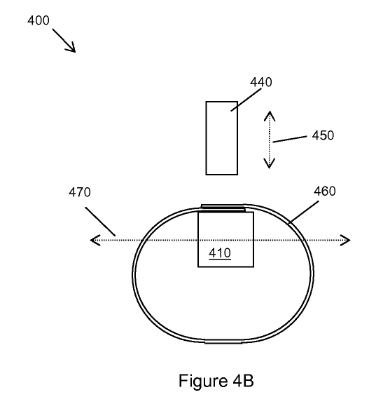

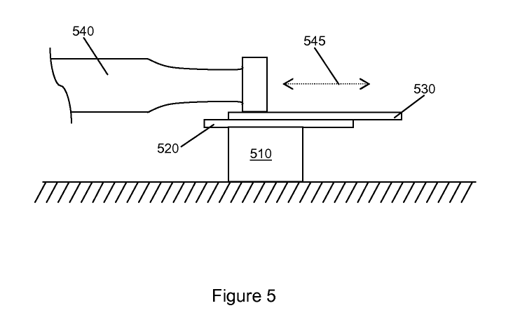

As is understood by those versed in the art, in some situations ultrasonic welding of certain types of materials such as, for example, metal, is best performed by positioning the sonotrode at an orientation such that the sonotrode is substantially parallel to the materials being welded. FIG. 5 shows an exemplary system for welding sheets of materials such as metal. As shown in FIG. 5, a sonotrode 540, which may be the same type of sonotrode 140 shown in FIG. 1A, or sonotrode 440 shown in FIG. 4, is positioned such that its longitudinal axis is substantially horizontal and parallel to the sheets 520 and 530 that are placed on an anvil 510. As is further understood by those versed in the art, the welding of materials in respect of which the sonotrode delivers ultrasonic energy that is substantially parallel to the sheets is based not on the formation of a melting bond between the sheets, but rather on a complex process involving static forces, oscillating shearing forces and a moderate temperature increase in the welding area. (It has been observed for metal welders in this substantially parallel configuration that, while it may be desirable to incline the weld head at a small angle with respect to parallel to provide clearance for the workpiece, an incline of more than about 8 degrees results in a substantial decrease in the quality of the weld.)

A parallel (or horizontal) configuration is not typically used per ultrasonic plastic welding systems. A parallel configuration applies a scrubbing motion to the workpieces under compacting pressure, resulting in intermingling of metal atoms across the seam, forming a metallurgical bond. This phenomenon (sometimes referred to as the formation of a “solid solution”) does not require melting of the metals. While this parallel configuration works for achieving welds in metals, this parallel scrubbing action has generally been observed to be a less effective configuration for welding plastics. In the perpendicular configuration, repeated compression of the work material at high cycle rates (typically 20 kHz or higher) contributed to heating of thermoplastic material from within the material itself, quickly and efficiently reaching melting temperature (typically within 100 milliseconds).

Despite the fact that the parallel welding configuration is not generally preferred in the art for the welding of plastics, the inventors have determined that for certain thicknesses and/or configurations of the plastic sheets, the strength of the resulting weld between the plastic sheets 120, 130 of FIG. 1A may be improved by orienting the sonotrode 140 in a non-perpendicular alignment with respect to the sheets 120 and 130 such that the ultrasonic energy directed at the welding points of the sheets has a parallel component (which may be calculated as U*cos(α), where U represents the energy level of the ultrasonic vibrations 145 generated by the sonotrode). The parallel component is illustrated as item 150 in FIG. 1B. The parallel component 150 of the energy delivered thus causes the ensuing welding process that takes place at the welding points of the sheets to be based, at least in part, on the welding process that occurs when welding metal sheets, as described above. The ultrasonic energy delivered to the sheets 120 and 130 may also have a perpendicular component (which is illustrated as item 160 in FIG. 1B and may be calculated as U*sin(α)), causing the welding of the two sheets 120 and 130 to be also based on the melted bond process, as describe above with respect to FIG. 4A. Accordingly, the resultant weld at the welding points of the sheets 120 and 130 has aspects of both the parallel weld and plunge weld geometries.

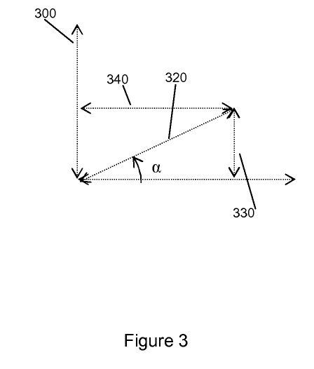

FIG. 3 shows that the non-vertical alignment of system 100 involves a combination of actions that appear to enhance the strength of the weld zone produced by system 100. The perpendicular force 300 exerted by the sonotrode 140 onto the sheets 120, 130 is one action. The non-perpendicular ultrasonic vibrations component 320 delivered by the sonotrode 140 to the sheets 120, 130 is another action. As shown in FIG. 3, and as previously explained, the ultrasonic vibrations 320 may comprise a perpendicular component 330 (sometimes referred to as a compressive component) and a parallel component 340 (sometimes referred to as a sliding component).

The inventors understand the non-perpendicular weld configuration to create a bond having at least two aspects: (1) a bond caused by melting and resetting of the thermoplastic material; and (2) a bond caused by surface distortions induced by the parallel component of the ultrasonic energy. These surface distortions may cause the plastic sheets to grab one another in a similar fashion to a hook-and-loop closure system.

The strength of the resultant weld between the sheets 120 and 130 may depend to an extent upon the size of the angle α in the non-perpendicular alignment. Depending on the materials to be welded and their respective thickness, different angles may be used to achieve the best results. The angle that is to be used for a particular weld may also depend on the speed at which the materials may be moving when a continuous seam line weld, as more particularly described below, is desired. The angle α should be less than 90 degrees so as to enhance the strength of the resulting weld between the sheets of material 120, 130, e.g., so as to produce a relatively high-quality weld. Preferably, the angle α is less than about 65 degrees and more than about 8 degrees. Still more preferably, the angle α is about 45 degrees.

In operation, two sheets 120 and 130 of a material such as plastic are placed on anvil 110. It will be understood that additional sheets may also be placed on the anvil for welding with the sheets 120 and 130, and that materials other than thermoplastic which have also been traditionally welded using plunge ultrasonic welding may also be used. A sonotrode 140 is disposed above the sheets in a non-vertical orientation such that the sonotrode's longitudinal axis 141 forms an angle α with respect to the surface of the sheets 120 and 130. Additionally, if a seam line weld is to be made along the entire length of the sheets, the sheets may be moved during the welding process to accomplish this type of a weld. Alternatively, the sonotrode itself may be moved or rolled across the length of the seam during the weld process. The sonotrode is activated and ultrasonic vibrations 145 are directed at the sheets. The parallel component of the ultrasonic vibration causes the sheets to become fused in a manner similar to the welding of metal sheets. At the same time, the perpendicular component of the ultrasonic vibrations causes the sheets to also weld through a melted bond process (i.e., the temperature at the welding area increases and causes the material to melt at least partially). The sonotrode 140 may also be displaced along the perpendicular direction so as to exert a vertical or compression force on the sheets.

As previously described, the angle α of interest in the present disclosure is the angle that is formed between the path along which the ultrasonic vibrations travel and the tangent to the surface being welded. In some embodiments, such as the embodiment shown in FIG. 1A, the longitudinal axis 141 of the sonotrode 140 may be aligned with the path 145 of the ultrasonic vibrations, so that that axis 141 and that path 145 form the same angle α with the tangent to the surface being welded. In some embodiments, the axis 141 may not be aligned with the path 145 of ultrasonic vibrations, since the axis of the working end 142 of the sonotrode may be disposed at an angle relative to the axis 141 of the sonotrode.

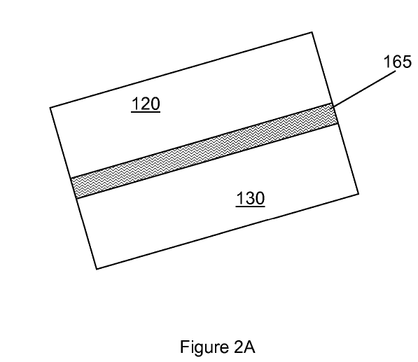

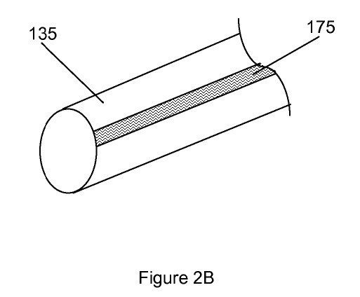

As previously noted, in some embodiments the non-perpendicular welding performed by the system 100 shown in FIG. 1A may be used to achieve a continuous weld of arbitrary length. In such embodiments, thin plastic sheets rolled, for example, on two separate spools (not shown) may be drawn by a drawing mechanism (also not shown) such that they are placed on the anvil 110 with an overlapping seam region. The sonotrode 110, in those embodiments, directs non-perpendicular ultrasonic vibrations at the sheets, thereby causing the two sheets to weld. As the sheets continue to move over the anvil, with the welded parts of the sheets moving off the surface of the anvil, and non-welded parts of the sheets being placed over the surface of the anvil, a seam line weld, having, for example, a relatively flat weld zone such as the flat weld zone 165 shown in FIG. 2A, is formed. Where the sheets are continuously fed through the weld zone, continuous seams of arbitrary length may be achieved. Alternatively, the sonotrode itself may be moved or rolled across a region to be welded, creating a continuous seam of a limited length.

In other embodiments, the system 100 of FIG. 1A may be used to weld a single sheet onto itself to form a tube. In yet other embodiments, a continuously moving sheet may be welded onto itself to form a continuous tube. In those embodiments, a plastic sheet, for example, is drawn from a spool (not shown) by a drawing mechanism (also not shown). The plastic sheet is wrapped over a rod or mandrel (not shown) that allows two opposite edges of the sheet to be placed together with an overlapping seam region, forming a tube. The sonotrode 140, which is oriented at a non-perpendicular angle α with respect to the plane tangential to the sheet at the point where its two opposite edges meet, applies ultrasonic vibrations 145 to the seam region, thereby causing the sheet to weld along that region, and forming a tube. As welded parts of the tube move off the rod, and non-welded parts of the sheet are wrapped over the rod, a seam line weld, having, for example, a relatively curved weld zone such as the curved weld zone 175 shown in FIG. 2B, is formed.

It will be apparent from FIG. 1A that in this non-perpendicular configuration the anvil 110 (or mandrel) may be held fixed while the sonotrode 140 rotates about its axis 141 to facilitate the continuous and uniform feeding of the plastic materials through the weld zone. In this way, with the non-perpendicular welding system described herein, continuous welds of indefinite length may be formed (in either sheets or tubes). This is in contrast to the plunge-welding configuration shown in FIG. 4A and FIG. 4B and discussed above.

In an additional aspect, the inventors have observed that an embodiment of a welding system described herein can achieve continuous welding at a rate suitable for production-scale applications. As previously discussed, a disadvantage of the traditional plunge-weld configuration for continuous welding applications of thin plastic sheets (e.g. sheets of 2-4 mils thickness or less) is that it can be difficult to obtain consistent, controlled melting and fusion of the sheets while still maintaining a sufficiently rapid feed rate of material through the weld zone.

Using an embodiment of a non-perpendicular welding configuration as described herein, the inventors have achieved continuous welding of, for example, 3-mil polyester sheets, at weld rates as high as approximately 12 meters per minute or higher. In these experiments, the sonotrode head was moved across the weld area rather than feeding the material through the weld zone. Nevertheless, it is expected that moving feeding the material through the weld zone is equivalent to moving the head across the workpiece. Thus, if a weld of adequate quality can be obtained by moving the sonotrode across the workpiece at a particular rate, a weld of adequate quality can also be obtained by holding the sonotrode stationary (except for rotation about its axis) and feeding the material through the weld zone at the same rate.

Using an aluminum sonotrode with a Stapla ST-30 model seam welder operated with a Stapla model USC-2 20 kHz controller, the inventors performed tests on samples of 3-mil thickness polyester sheets. Welds were formed using a variety of system parameters, including a range of weld rates and a range of values for the angle α. The quality of the welds was then tested, both by visual inspection and by a pull test, in which the force required to pull apart the welded sheets was measured. In a visual inspection, the weld is examined for evidence of plastic melt at the weld seam, including (a) a clear, watery appearance; (b) evidence of plastic melt flow (flash) at the edges of the weld seam; and/or (c) indication of a reformed material thickness—a compressed zone—coincident with the weld seam. In a pull test, a force is applied to the workpiece in an attempt to pull the weld apart. It may then be observed whether the weld withstands pull forces required for a particular application.

Using such inspection techniques to test welds created with varying parameters, it was observed that the maximum weld rate that would yield a weld of acceptable strength and quality depended upon the angle α. In particular, it was observed that at an angle α=approximately 45 degrees, acceptable welds could be obtained at the highest weld rates.

As will be understood by those of ordinary skill in the art, the disclosed systems and methods are not limited to sheet materials or sheet thicknesses. In fact, the disclosed systems and methods can be used to weld a variety of plastic sheets and sheet thicknesses, as well as other types of materials. The plastic sheets or tubes may include thermoplastic sheets, e.g., sheets of nylon, polypropylene, polyethylene, polyesterine, and polyester.

Although in all accompanying figures, exemplary systems have been illustrated such that weld seams lie in the horizontal plane; the plunge weld configuration applies ultrasonic vibrations in a vertical direction; and the parallel configuration applies ultrasonic vibrations in a horizontal direction, it will be understood that the relevant orientation is the orientation of the sonotrode with respect to the weld seam (i.e., whether the ultrasonic vibrations are applied in a direction parallel to or perpendicular to the weld seam or at some angle α in between) rather than with respect to the earth's surface (i.e., horizontal or vertical).

Unless otherwise stated, use of the word “substantially” can be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun can be understood to be used for convenience and to include one, or more than one of the modified noun, unless otherwise specifically stated.

Those of ordinary skill in the art will recognize or be able to ascertain many equivalents to the exemplary embodiments described herein by using no more than routine experimentation. Such equivalents are intended to be encompassed by the scope of the present disclosure. Accordingly, the present disclosure is not to be limited to the embodiments described herein, can include practices other than those described, and is to be interpreted as broadly as allowed under prevailing law.

What is claimed is:

1. A system for ultrasonic welding of plastic, comprising:
a) an anvil; and
b) a sonotrode having a working end,
wherein:
at least a portion of a first thin plastic material to be welded is disposed adjacent the anvil; and
at least a portion of a second thin plastic material to be welded is disposed adjacent the said at least a portion of the first plastic material, such that the said at least a portion of the first plastic material is between the said at least a portion of the second plastic material and the anvil; and
the said working end of the said sonotrode is oriented at an angle α of less than 90 degrees with respect to a tangent to the surface of the said at least a portion of the second plastic material.

2. The system of claim 1, wherein the angle α is greater than about 8 degrees and less than about 65 degrees.

3. The system of claim 2, wherein the angle α is about 45 degrees.

4. The system of claim 2, wherein the first thin plastic material and the second thin plastic material are plastic sheets.

5. The system of claim 2, wherein the first thin plastic material and the second thin plastic material are areas on one plastic sheet.

6. The system of claim 2, wherein the plastic is thermoplastic.

7. The system of claim 6, wherein the thermoplastic comprises at least one member of the group nylon, polypropylene, polyethylene, polystyrene and polyester.

8. The system of claim 4, where the sheets have thicknesses less than about 0.15 mm.

9. The system of claim 8, where the sheets have thicknesses less than about 0.10 mm.

10. The system of claim 2, wherein at least a portion of a third thin plastic material to be welded is disposed adjacent the said at least a portion of the second plastic material, such that the said at least a portion of the second plastic material is between the said at least a portion of the third plastic material and the said at least a portion of the first plastic material.

11. The system of claim 2, wherein the working end of the sonotrode is disposed at an angle with respect to the sonotrode.

12. The system of claim 2, wherein the working end of the sonotrode has a beveled edge.

13. A method for ultrasonic welding of plastic, comprising:
a) providing an anvil;
b) providing a sonotrode having a working end;
c) disposing at least a portion of a first thin plastic material to be welded adjacent the anvil;
d) disposing at least a portion of a second thin plastic material to be welded adjacent the said at least a portion of the first plastic material, such that the said at least a portion of the first plastic material is between the said at least a portion of the second plastic material and the anvil;
e) orienting the said working end of the said sonotrode at an angle α of less than 90 degrees with respect to a tangent to the surface of the said at least a portion of the second plastic material; and
f) applying ultrasonic vibrations to the said at least a portion of the second plastic material.

14. The method of claim 13, wherein the angle α is greater than about 8 degrees and less than about 65 degrees.

15. The method of claim 14, wherein the angle α is about 45 degrees.

16. The method of claim 14, wherein the first thin plastic material and the second thin plastic material are plastic sheets.

17. The method of claim 14, wherein the first thin plastic material and the second thin plastic material are areas on one plastic sheet.

18. The method of claim 14, wherein the plastic is thermoplastic.

19. The method of claim 18, wherein the thermoplastic comprises at least one member of the group nylon, polypropylene, polyethylene, polystyrene and polyester.

20. The method of claim 16, where the sheets have thicknesses less than about 0.15 mm.

21. The method of claim 20, where the sheets have thicknesses less than about 0.10 mm.

22. The method of claim 14, further comprising disposing at least a portion of a third thin plastic material to be welded adjacent the said at least a portion of the second plastic material, such that the said at least a portion of the second plastic material is between the said at least a portion of the third plastic material and the said at least a portion of the first plastic material, and the said ultrasonic vibrations applied to the said at least a portion of the second plastic material are applied through the said at least a portion of the third plastic material.

23. The method of claim 14, further comprising disposing the working end of the sonotrode at an angle with respect to the sonotrode.

24. The method of claim 14, wherein the working end of the sonotrode has a beveled edge.

25. The method of claim 14, further comprising displacing the working end so as to exert a compression force on the said at least a portion of the first thin plastic material and at least a portion of the second thin plastic material in a direction perpendicular to the surfaces thereof.

26. The method of claim 14, further comprising moving the first thin plastic material and the second thin plastic material in a lateral direction relative to the working end while applying ultrasonic vibrations.

27. The method of claim 14, further comprising moving the working end in a lateral direction relative to the first thin plastic material and the second thin plastic material while applying ultrasonic vibrations.
